(19) United States
(12) Patent Application Publication
(10) Pub. No.: US 2008/0219669 A1
(43) Pub. Date: Sep. 11, 2008

(54) SDH/SONET Convergent Network

(75) Inventor: Serge F. FOURCAND, Fairview, TX (US)

Correspondence Address: CONLEY ROSE, P.C., 5601 GRANITE PARKWAY, SUITE 750, PLANO, TX, 75024, US

(73) Assignee: FUTUREWEI TECHNOLOGIES, INC., Plano, TX (US)

(21) Appl. No.: 12/040,128

(22) Filed: Feb. 29, 2008

Related U.S. Application Data
(60) Provisional application No. 60/893,073, filed on Mar. 5, 2007.

(51) Int. Cl. H04J 14/08

(52) U.S. Cl. 398/98

(57) ABSTRACT

An apparatus comprising at least one component configured to implement a method comprising inserting best effort packet (BEP) data into a synchronous digital hierarchy (SDH)/synchronous optical network (SONET) frame without encapsulating or reframing the BEP data. Also disclosed is an apparatus comprising a SDH/SONET framer, and a multiplexer coupled to the SDH/SONET framer, wherein the multiplexer is configured to receive native-form BEP data. Included is an apparatus comprising at least one component configured to implement a method comprising receiving time division multiplexed (TDM) data, receiving BEP data, switching the TDM data using a TDM switch fabric, switching the BEP data using a packet switch fabric, and transmitting at least some of the TDM data and the BEP data over a single interface without encapsulating the BEP data.

### CROSS-REFERENCE TO RELATED APPLICATIONS

This application claims priority to U.S. Provisional Patent Application Ser. No. 60/893,073 filed Mar. 5, 2007 by Fourcand and entitled “SDH/SONET Convergent Network,” which is incorporated by reference herein as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Ethernet is the preferred protocol for many types of networks because it is flexible, decentralized, and scalable. Ethernet is flexible in that it allows variable-sized data packets to be transported across different types of mediums using various nodes each having different transmission speeds. Ethernet is decentralized in that it allows the end devices to transmit and receive data without oversight or intervention from a centralized server or party. Furthermore, Ethernet is scalable in that it can be implemented in both small-scale and large-scale networks. These advantages make Ethernet a preferred choice for data distribution in many computer networks.

Unfortunately, Ethernet has not been widely implemented in networks carrying time division multiplexed (TDM) data. Specifically, Ethernet does not provide a sufficient Quality of Service (QoS) to meet the stringent jitter and data loss requirements for voice traffic in the public switched telephone network (PSTN) and other TDM networks. Instead, TDM traffic is carried by highly synchronized networks, such as synchronous optical networks (SONET) and synchronous digital hierarchy (SDH) networks. Various enhancements, such as Generic Framing Procedure (GFP) and Link Access Procedure over SDH (LAPS) have been proposed to allow Ethernet to be integrated with TDM networks, but these enhancements fail to couple the flexibility of Ethernet with the high QoS requirements of TDM networks. Moreover, they do not support the integration of Ethernet layer two-based switching and SDH/SONET nodes.

### SUMMARY

In one aspect, the disclosure includes an apparatus comprising at least one component configured to implement a method comprising inserting best effort packet (BEP) data into a SDH/SONET frame without encapsulating or reframing the BEP data.

In another aspect, the disclosure includes an apparatus comprising a SDH/SONET framer, and a multiplexer coupled to the SDH/SONET framer, wherein the multiplexer is configured to receive native-form BEP data.

In a third aspect, the disclosure includes an apparatus comprising at least one component configured to implement a method comprising receiving TDM data, receiving BEP data, switching the TDM data using a TDM switch fabric, switching the BEP data using a packet switch fabric, and transmitting at least some of the TDM data and the BEP data over a single interface without encapsulating the BEP data.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a payload-level overlay synchronous timeslot scheme.

FIG. 2 is a schematic diagram of an embodiment of a payload-level overlay synchronous timeslot scheme multiplexing architecture.

FIG. 3 is a schematic diagram of an embodiment of a frame-level overlay synchronous timeslot scheme.

FIG. 4 is a schematic diagram of an embodiment of a frame-level overlay synchronous timeslot scheme multiplexing architecture.

FIG. 5 is a schematic diagram of an embodiment of an overlay synchronous timeslot scheme data protection and load sharing architecture.

FIG. 6 is a schematic diagram of an embodiment of a GFP network architecture.

FIG. 7 is a schematic diagram of an embodiment of an overlay synchronous timeslot scheme network architecture.

FIG. 8 is a schematic diagram of an embodiment of a network flow control architecture.

FIG. 9 is a schematic diagram of another embodiment of a network flow control architecture.

FIG. 10 is a schematic diagram of an embodiment of a timeslot map indexing architecture.

FIG. 11 is an illustration of an embodiment of the 7B/8B encoding scheme in a SDH/SONET frame.

FIG. 12 is an illustration of an embodiment of the 8B/9B encoding scheme in a SDH/SONET frame.

FIG. 13 is a table of the inter-packet gap (IPG) sizes for various packet size and clock tolerance values.

FIG. 14 is a schematic diagram of another embodiment of a network architecture.

FIG. 15 is an illustration of one embodiment of a general-purpose computer system.

### DETAILED DESCRIPTION

It should be understood at the outset that, although an illustrative implementation of one or more embodiments are provided below, the disclosed systems, methods, or both may be implemented using any number of techniques, whether currently known or in existence. The disclosure should in no way be limited to the illustrative implementations, drawings, and techniques illustrated below, including the examples of designs and implementations illustrated and described herein, but may be modified within the scope of the appended claims along with their fill scope of equivalents.

Disclosed herein is a method and system for carrying packet-based network data, such as Ethernet, in TDM-based networks, such as SDH/SONET. Specifically, a plurality of overlay synchronous timeslot schemes are disclosed that allow native-form best effort packets (BEPs) to be multiplexed into SDH/SONET frames without encapsulating or reframing the BEPs. Architectures are disclosed for multiplexing the BEPs with the SDH/SONET frames at the payload level or at the frame level. These architectures allow for data protection, load sharing, backpressure, and flow control within the network. In addition, these architectures allow network flexibility by using existing TDM and Ethernet layer two switching fabrics. Furthermore, the disclosed methods and systems maintain many existing SDH/SONET features, such as operations, administration, and maintenance (OAM), protection mechanisms, pointer adjustments, and network clock synchronization mechanisms.

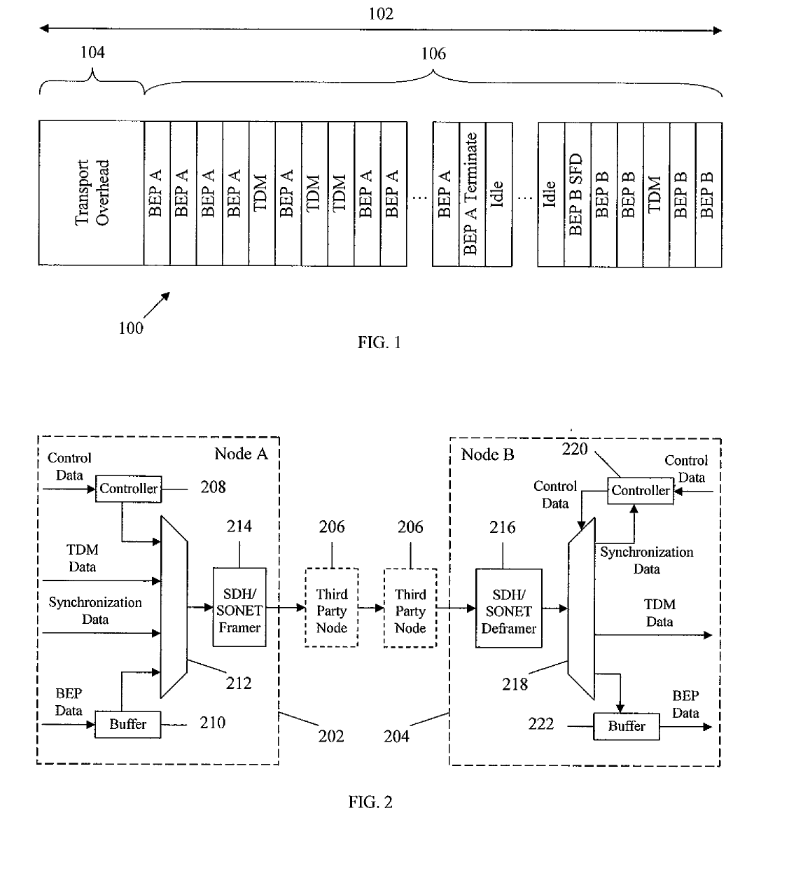

FIG. 1 illustrates an embodiment of a payload-level overlay synchronous timeslot scheme for a SDH/SONET frame 100. As used herein, the SDH/SONET frames may be any data structure that may be transported using circuit-switched or TDM-based networks. The SDH/SONET frames include TDM data, e.g. voice-based traffic, and packet-based traffic that has been mapped to the SDH/SONET payload using BEP to TDM conversion techniques, such as GFP or LAPS. The SDH/SONET frame 100 comprises a transport overhead 104, which may include control data, synchronization data, or any other data used to transport the SDH/SONET frame through the PSTN or any other network. For example, the transport overhead may include section overhead, line overhead, and path overhead. The SDH/SONET frame 100 also comprises a payload 106, which comprises a plurality of timeslots that may be configured to carry TDM data or BEP data. As used herein, BEP data may be any type of packet-based data structure normally transported in a packet switched network, including Ethernet packets, Internet Protocol (IP) packets, and Asynchronous Transfer Mode (ATM) cells. The BEP data in the payload 106 may be in its native form and may not be encapsulated or reframed. As used herein, encapsulation may refer to the addition of a temporary header to a data structure, for example, so that a data structure in one protocol can be transported through a network using a different protocol. The SDH/SONET frame 100 contains a sufficient amount of transport overhead 104 and payload 106 to be transported within a synchronization window 102, which may be about 125 microseconds (μs). The SDH/SONET frame 100 may be synchronized and phase aligned with the synchronization window 102 using any available standard SDH/SONET frame alignment method, such as using pointers H1 and H2 or using the H3 pointer action octet.

The timeslots in the payload 106 may comprise a mixture of TDM data and BEP data. In such a case, the TDM data may have priority over the BEP data. Specifically, any idle timeslots in the payload 106, e.g. those timeslots that are not actually carrying any TDM data, may be substantially filled with BEP data. FIG. 1 illustrates the case where the payload 106 begins with BEP data, specifically BEP A. The idle timeslots in the payload 106 are filled with octets from BEP A until some TDM data is received. The TDM data interrupts the BEP data in that the timeslots are filled with TDM data until the TDM data is no longer being received, at which time the timeslots, which are now idle, may continue to be filled with BEP data. This interruption can take place at any point during the transmission of the BEP data, for example, when the BEP data is actively being transmitted or when the BEP data is idle. This feature is shown in the first ten timeslots and last five timeslots of the payload 106. Also shown in FIG. 1, one or more timeslots may be left idle between BEPs so that the BEPs may be distinguished from one another, e.g. BEP A may be distinguished from BEP B. These idle timeslots between BEPs may be interrupted by TDM data if desired. The start of a new BEP, e.g. BEP B, may be indicated by a start of frame delimiter (SFD). While the SDH/SONET frame depicted in FIG. 1 contains two BEPs, any amount of BEP data may be communicated within the payload 106. For example, the payload 106 may contain no BEP data, part of a BEP, exactly one BEP, or multiple BEPs. The mapping of the BEP data to the timeslots may be indicated in a timeslot map, which is discussed in further detail below.

FIG. 2 depicts an embodiment of a functional block diagram of the egress and ingress ports of two nodes. An egress port 202 of a node A is in communication with an ingress port 204 of a node B, and may transport the payload level overlay synchronous timeslot scheme over SDH/SONET interfaces. The egress port 202 is configured to receive BEP data, TDM data, synchronization data, and control data. The control data may include the transport overhead discussed above, the timeslot map discussed below, and/or any additional control data. A controller 208 uses the control data to multiplex the various data streams, as described herein. A buffer 210 may store the BEP data until the BEP data is needed by the egress multiplexer 212. The BEP data may be in its native form and may not be encapsulated. The egress multiplexer 212 multiplexes the data from the controller 208 and the buffer 210 with the TDM data and the synchronization data. Specifically, the egress multiplexer 212 selects data from one of the inputs for each octet within the synchronization window. Upon selecting an input, the egress multiplexer 212 communicates the data received on the selected input to a SDH/SONET framer 214 for transport over a communication medium.

The controller 208 may provide a mechanism to identify the position of each timeslot within the synchronization window. The controller 208 may also provide a mechanism to differentiate timeslots that are assigned to TDM data from unassigned timeslots. The controller 208 may also instruct the egress multiplexer 212 to select each of the inputs. For example, at the beginning of the synchronization window, the controller 208 may instruct the egress multiplexer 212 to accept the transport overhead and timeslot map from the controller 208, and then accept the synchronization data. The controller 208 may then instruct the egress multiplexer 212 to accept the TDM data and the BEP data. Specifically, the controller 208 may instruct the egress multiplexer 212 to fill the timeslots with TDM data if it is available, otherwise to fill the timeslots with BEP data. Upon completion of the synchronization window, the controller 208 may instruct the egress multiplexer 212 to send the SDH/SONET frame to the SDH/SONET framer 214. The SDH/SONET framer 214 may include an SDH/SONET interface circuit as defined in any applicable SDH/SONET specification, such as Telcordia GR-253 and ITU-T G.707, both of which are incorporated by reference herein. As such, the SDH/SONET frame conforms to these standards and can be transported via third party, e.g. conventional, SDH/SONET nodes 206. In addition, the links over which the various data streams in FIG. 2 are transmitted may be optical or electrical links, and are generally compatible with the components to which they arc coupled. For example, the link coupling the egress multiplexer 212 to the to the SDH/SONET framer 214 may be an electrical link, whereas the link coupling the SDH/SONET framer 214 to the SDH/SONET deframer 216 may be an optical link containing one or more optional optical-electric-optical (OEO) converters.

The ingress port 204 of node B is configured to receive the data transported over the communication medium on an SDH/SONET deframer 216. The SDH/SONET deframer 216 may include an SDH/SONET interface circuit as defined in any applicable SDH/SONET specification, such as Telcordia GR-253 and ITU-T G.707. The SDH/SONET deframer 216 forwards the data to an ingress demultiplexer 218, which demultiplexes the data stream. The ingress demultiplexer 218 also forwards the data to a controller 220, a TDM data output, or a buffer 222 as instructed by the controller 220. The buffer 222 may be configured to store the BEP data received from the ingress demultiplexer 218. The controller 220 may control the ingress demultiplexer 218 using control information received from the ingress demultiplexer 218 and/or from other components in node B. The controller 220 may provide a mechanism to activate internally stored data upon reception of the control information from the ingress demultiplexer 218. As part of the control, the controller 220 may use the timeslot map provisioned within node B or received over the SDH/SONET deframer 216 to control the demultiplexing of the data stream.

Similar to the controller 208, the controller 220 may provide a mechanism to identify the position of each timeslot within the synchronization window. The controller 220 may also provide a mechanism to differentiate timeslots that are assigned to TDM data from unassigned timeslots. The controller 220 may also instruct the ingress demultiplexer 218 to forward the received data to the outputs. In an embodiment, the controller 220 may include a mechanism to activate internally stored data upon reception of the synchronization data. When the synchronization window begins, the controller 220 may instruct the ingress demultiplexer 218 to send the transport overhead to the controller 220. In an alternative embodiment, the ingress demultiplexer 218 may contain logic that recognizes the start of the synchronization window such that the transport overhead is sent to the controller 220 without any instructions from the controller 220. The ingress demultiplexer 218 may then send the synchronization data and/or the timeslot map to the controller 220. The controller 220 may then use the timeslot map to instruct the ingress demultiplexer 218 to distribute the received data to the TDM data output and the buffer 222.

The egress port 202 and the ingress port 204 may each be implemented as part of a communication interface between two nodes. In an embodiment, the egress port 202 and the ingress port 204 may each be implemented as part of a line card that supports metro, access, or core network communications. Further, while only the egress port 202 of node A and the ingress port 204 of node B are shown, full-duplex communications may be supported by each of nodes A and B including an ingress port on node A and an egress port on node B. In such a case, an egress port of node B and an ingress port of node A may also communicate with each other, in addition to the egress port 202 of node A and the ingress port 204 of node B communicating with each other.

FIG. 3 illustrates an embodiment of a frame-level overlay synchronous timeslot scheme for a SDH/SONET frame 300. Similar to the SDH/SONET frame 100 in FIG. 1, the SDH/SONET frame 300 in FIG. 3 comprises a transport overhead 304, which may include control data, synchronization data, or any other data used to transport the SDH/SONET frame through the PSTN or any other network. The SDH/SONET frame 300 also comprises a payload 306, which comprises a plurality of timeslots that may be configured to carry TDM data. The timeslots in the payload 306 may comprise a mixture of TDM data and BEP data substantially as described in conjunction with the SDH/SONET frame 100. In addition, the SDH/SONET frame 300 contains a sufficient amount of transport overhead 304 and payload 306 to be transported within a synchronization window 302, which may be about 125 μs. The SDH/SONET frame 300 may be synchronized and phase aligned with the synchronization window 302 using any available standard SDH/SONET frame alignment method, such as using pointers H3 and H2 or using the H3 pointer action octet.

However, unlike the payload-level overlay synchronous timeslot scheme, the frame-level overlay synchronous timeslot scheme allows the transport overhead 304 to include a mixture of overhead data and BEP data. Specifically, the transport overhead 304 may comprise a significant amount of empty, unused, or idle timeslots. As such, BEP data may be placed in such timeslots with its location designated by a timeslot map, indicated by one or more bits, or any other mechanism. In such a case, the overhead data may have priority over the BEP data. Specifically, any idle timeslots in the transport overhead 304, e.g. those timeslots that are not actually carrying any overhead data, may be substantially filled with BEP data. FIG. 3 illustrates the case where a single octet of BEP data, BEP A, has been placed in the transport overhead 304. The idle timeslots in the transport overhead 304 are filled with octets from BEP A until some overhead data is received. The overhead data interrupts the BEP data in that the timeslots are filled with overhead data until the overhead data is no longer being received, at which time the timeslots, which are now idle, may continue to be filled with BEP data. This interruption can take place at any point during the transmission of the BEP data, for example, when the BEP data is actively being transmitted or when the BEP data is idle. One or more timeslots may be left idle between BEPs so that the BEPs may be distinguished from one another. These idle timeslots between BEPs may be interrupted by overhead data if desired. While the SDH/SONET frame depicted in FIG. 3 contains one BEP octet in the transport overhead 304, any amount of BEP data may be communicated within the transport overhead 304. For example, the transport overhead 304 may contain no BEP data, part of a BEP, exactly one BEP, or multiple BEPs. Regardless of their location, e.g. in the transport overhead 304 or the payload 306, the BEP data may be in its native form and may not be reframed or encapsulated. The mapping of the BEP data to the timeslots may be indicated in a timeslot map, which is discussed in further detail below.

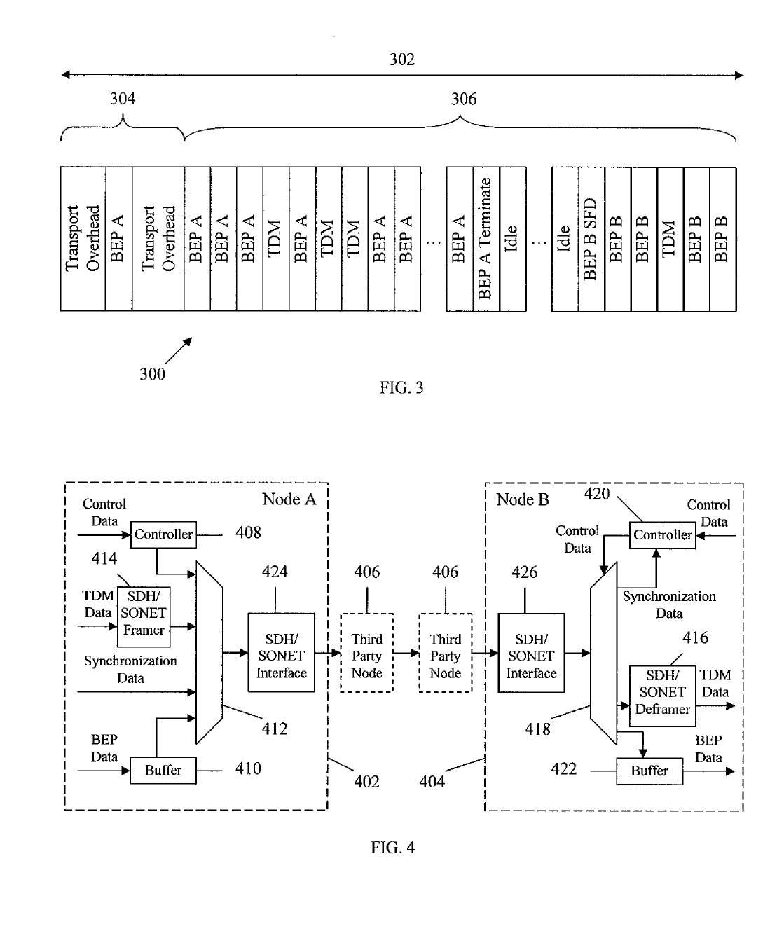

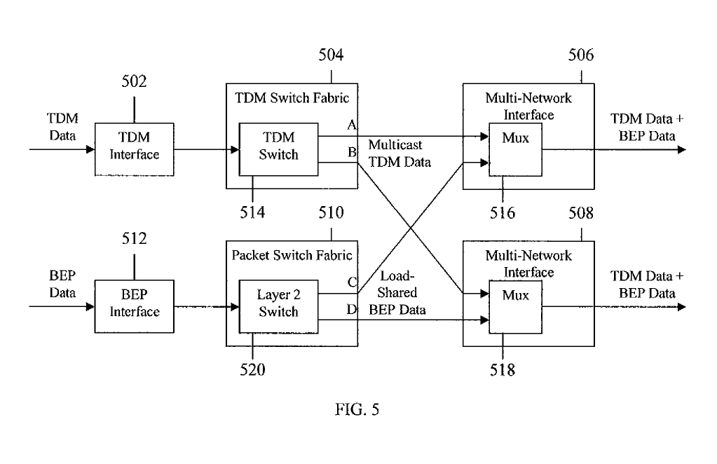

FIG. 4 depicts an embodiment of a functional block diagram of the egress and ingress ports of two nodes. An egress port 402 of a node A is in communication with an ingress port 404 of a node B, and may transport the frame level overlay synchronous timeslot scheme over SDH/SONET interfaces. The egress port 402 is configured to receive BEP data, TDM data, synchronization data, and control data. The control data may include the transport overhead discussed above, the timeslot map discussed below, and/or any additional control data. A controller 408 uses the control data to multiplex the various data streams, as described herein. A buffer 410 may store the BEP data until the BEP data is needed by the egress multiplexer 412. The BEP data may be in its native form and may not be encapsulated. The SDH/SONET framer 414 frames the TDM data into SDH/SONET frames. The egress multiplexer 412 multiplexes the data from the controller 408 and the buffer 410 with the framed TDM data and the synchronization data. Specifically, the egress multiplexer 412 selects data from one of the inputs for each octet within the synchronization window. Upon selecting an input, the egress multiplexer 412 communicates the data received on the selected input to a SDH/SONET interface 424 for transport over a communication medium. The SDH/SONET interface 424 circuit may be as defined in any applicable SDH/SONET specification, such as Telcordia GR-253 and ITU-T G.707. As such, the SDH/SONET frame conforms to these standards and can be transported via third party, e.g. conventional, SDH/SONET nodes 406.

The controller 408 may provide a mechanism to identify the position of each timeslot within the synchronization window. The controller 408 may also provide a mechanism to differentiate timeslots that are assigned to TDM data from unassigned timeslots. The controller 408 may also instruct the egress multiplexer 412 to select each of the inputs. For example, at the beginning of the synchronization window, the controller 408 may instruct the egress multiplexer 412 to accept the transport overhead and timeslot map from the controller 408, and then accept the synchronization data. The controller 408 may then instruct the egress multiplexer 412 to accept the framed TDM data and the BEP data. Specifically, the controller 408 may instruct the egress multiplexer 412 to fill the timeslots with framed TDM data if it is available, otherwise to fill the timeslots with BEP data. Upon completion of the synchronization window, the controller 408 may instruct the egress multiplexer 412 to send the SDH/SONET frame to the SDH/SONET interface 424. In addition, the links over which the various data streams in FIG. 4 are transmitted may be optical or electrical links, and are generally compatible with the components to which they are coupled. For example, the link coupling the egress multiplexer 412 to the to the SDH/SONET interface 424 may be an electrical link, whereas the link coupling the SDH/SONET interface 424 to the SDH/SONET interface 426 may be an optical link containing one or more optional OEO converters.

The ingress port 404 of node B is configured to receive the data transported over the communication medium on an SDH/SONET interface 426. The SDH/SONET interface 426 circuit may be as defined in any applicable SDH/SONET specification, such as Telcordia GR-253 and ITU-T G.707 The SDH/SONET interface 426 forwards the data to an ingress demultiplexer 418, which demultiplexes the data stream. The ingress demultiplexer 418 also forwards the data to a controller 420, a SDH/SONET deframer 416, or a buffer 422 as instructed by the controller 420. The SDH/SONET deframer 416 may deframe the SDH/SONET frame and generate TDM data. The buffer 422 may be configured to store the BEP data received from the ingress demultiplexer 418. The controller 420 may control the ingress demultiplexer 418 using control information received from the ingress demultiplexer 418 and/or from other components in node B. The controller 420 may provide a mechanism to activate internally stored data upon reception of the control information from the ingress demultiplexer 418. As part of the control, the controller 420 may use the timeslot map provisioned within node B or received over the SDH/SONET interface 426 to control the demultiplexing of the data stream.

Similar to the controller 408, the controller 420 may provide a mechanism to identify the position of each timeslot within the synchronization window. The controller 420 may also provide a mechanism to differentiate timeslots that are assigned to TDM data from unassigned timeslots. The controller 420 may also instruct the ingress demultiplexer 418 to forward the received data to the outputs. In an embodiment, the controller 420 may include a mechanism to activate internally stored data upon reception of the synchronization data. When the synchronization window begins, the controller 420 may instruct the ingress demultiplexer 418 to send the transport overhead to the controller 420. In an alternative embodiment, the ingress demultiplexer 418 may contain logic that recognizes the start of the synchronization window such that the transport overhead is sent to the controller 420 without any instructions from the controller 420. The ingress demultiplexer 418 may then send the synchronization data and/or the timeslot map to the controller 420. The controller 420 may then use the timeslot map to instruct the ingress demultiplexer 418 to distribute the received data to the TDM data output and the buffer 422.

The egress port 402 and the ingress port 404 may each be implemented as part of a communication interface between two nodes. In an embodiment, the egress port 402 and the ingress port 404 may each be implemented as part of a line card that supports metro, access, or core network communications. Further, while only the egress port 402 of node A and the ingress port 404 of node B are shown, full-duplex communications may be supported by each of nodes A and B including an ingress port on node A and an egress port on node B. In such a case, an egress port of node B and an ingress port of node A may also communicate with each other, in addition to the egress port 402 of node A and the ingress port 404 of node B communicating with each other.

While the above description of the payload level overlay synchronous timeslot scheme and frame level overlay synchronous timeslot scheme focuses on inter-node transmission of the multiplexed BEP and TDM data, the payload level overlay synchronous timeslot scheme and frame level overlay synchronous timeslot scheme are applicable to internal links as well. For example, a node can be configured with a plurality of interconnected interfaces described herein. Such would allow the convergent transport of TDM and BEP data on pseudo-SDH/SONET backplanes, and would allow such backplanes to interconnect interface cards and switch fabrics within the node.

In an embodiment, a redundancy mode can be applied to the TDM and BEP data to take advantage of individual identification and transport of the TDM data and the BEP data in the overlay synchronous timeslot schemes. Specifically, when two or mode nodes are coupled together by a plurality of links, a protection mechanism may be established between the nodes such that the TDM data is transmitted across two or more of the links, but the BEP data is load shared across the links. In such a case, the TDM data is transported to the receiving node even when one of the links connecting the nodes fails. In contrast, the BEP data can tolerate some lost packets and perhaps recover some lost packets using any available internet protocol (IP) protection mechanism, such as the transmission control protocol (TCP)/IP protocol. For example, BEP data affected by packet loss can be retransmitted by its source node. On the other hand, if both links remain active, the receiving node may simply drop one of the two sets of TDM data. It will be appreciated that these two nodes may be adjacent to one another, or one or more of the links connecting the two nodes may pass through one or more intermediate nodes.

FIG. 5 illustrates an embodiment of a redundancy mode that may be implemented as described above. Specifically, TDM data is received on a TDM interface 502, which may be a conventional SDH/SONET interface or one of the interfaces described above. The TDM data is sent to a TDM switch fabric 504, which may be a conventional SDH/SONET switching fabric that is configured to switch the TDM data between a plurality of egress ports. The TDM switch fabric 504 may comprise a TDM switch 514 that supports multicasting and copies the TDM data to egress ports A and B while maintaining the phase of the TDM data. Port A sends one copy of the TDM data to multi-network interface 506, and Port B sends the other copy of the TDM data to multi-network interface 508. Multi-network interfaces 506 and 508 may be similar to the interfaces described above.

Similar to the TDM data, BEP data is received on a BEP interface 512, which may be a conventional Ethernet interface or one of the interfaces described above. The BEP data is sent to a packet switch fabric 510, which may be a conventional packet switch fabric that is configured to switch the BEP data between a plurality of egress ports. The packet switch fabric 510 may comprise a layer two switch 520 that support trunking and distributes the BEP data to egress ports C and D in a load-sharing manner. Specifically, the layer two switch 520 may place some of the BEP data on egress port C, while the remaining BEP data is placed on egress port D. Port C sends its BEP data to multi-network interface 506, while Port D sends its BEP data to multi-network interface 508. The distribution of BEP data to ports C and D may be done using any available technique, including IEEE 802.3ad™ link aggregation, which is incorporated herein by reference.

Within the multi-network interface 506, a multiplexer 516 combines the TDM data from port A and the BEP data from port C, and sends the multiplexed data to an egress port. Similarly, a multiplexer 518 within multi-network interface 508 combines the TDM data from port B and the BEP data from port D, and sends the multiplexed data to an egress port. Consequently, the data streams leaving the multi-network interfaces 506 and 508 carry TDM data in a 1+1 protection scheme and load share the BEP data. In addition, the data streams leaving the multi-network interfaces 506 and 508 may be synchronized and phase aligned, e.g. due to the configuration shown in FIG. 5. Thus, multi-network interfaces 506 and 508 provide mixed-redundancy support on a single network interface.

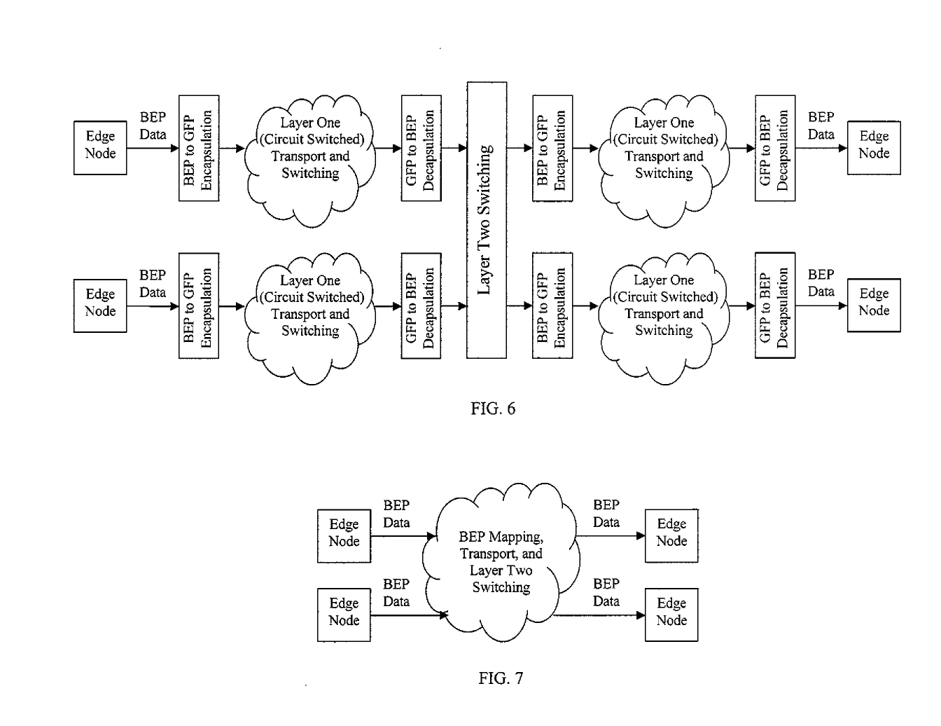

The overlay synchronous timeslot schemes described herein may allow more network flexibility than other methods of transporting BEP data across a SDH/SONET network. For example, GFP is one method that can be used to map Ethernet packet to SDH/SONET networks. As shown in FIG. 6, GFP is an encapsulation-based scheme that creates tunnels across the SDH/SONET network and requires new headers and new framing information to be generated for and removed from the BEPs at the tunnel ingress and egress. Thus, GFP treats the BEP data as circuit-switched data. As such, the BEP data cannot be switched by layer two packet switched fabric as it is being transported along the tunnel, but instead can only be switched when outside of the tunnel, e.g. at the tunnel ingress and egress. The cost and delays associated with GFP may make mapping and demapping the Ethernet packet at every network node cost-prohibitive and/or introduce unacceptable delay into the TDM and BEP data. Consequently, the mapping and demapping functions are typically performed only at the edges of the transport network. In some cases, one or more predefined layer two switching points may be located at convenient points within the network, thereby allowing layer two switching and statistical multiplexing to occur within the interior of the network. However, the GFP overhead make it impractical to have more than a few of these points within the network.

In contrast, the overlay synchronous timeslot schemes described herein may allow the TDM and BEP data to be transported across the network in their native form, e.g. without being encapsulated or reframed. As shown in FIG. 7, this feature allows the BEP data to be readily accessible at any location within the network. Thus, the BEP data can be switched throughout the network without the need for encapsulation or decapsulation. In addition, having the BEP data readily accessible and the Ethernet layer two switching distributed throughout the network allows the use of standard Ethernet redundancy mechanisms such as Link Aggregation and Spanning Tree. Such is not possible using GFP because circuit switched-based redundancy methods must be used when the BEP data is encapsulated, transported, and switched as circuit switched data. Consequently, the overlay synchronous timeslot schemes described herein may improve network flexibility and utilization, increase statistical multiplexing, reduce network complexity, and improve network economics.

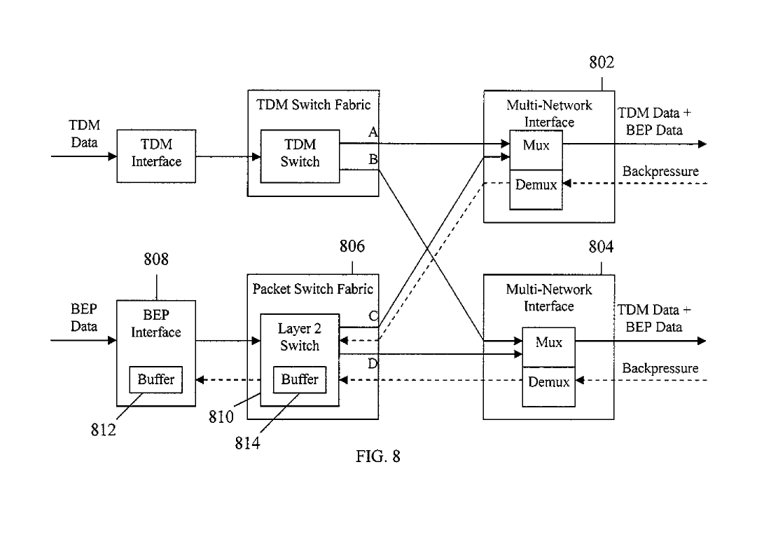

FIG. 8 illustrates an embodiment of the flow control that may be provided by the overlay synchronous timeslot schemes described herein. The flow control may be initiated when backpressure is received from one or more upstream nodes. Although the backpressure may be equally applicable to both the BEP data and the TDM data, typically backpressure will only be applied to the BEP data so that the TDM data is not delayed and the QoS of the TDM data will be maintained throughout the network. The backpressure may be indicated by one or more BEP or TDM octets or, more typically, by one or more bits in a BEP or the TDM data. For example, the backpressure may be applied using IEEE 802.3x™ control frames, e.g. PAUSE frames, proprietary Ethernet packets, or proprietary data transported as part of a TDM channel. The transport of backpressure using TDM channels may be particularly advantageous because it allows for a guaranteed bandwidth and periodicity, which results in a highly deterministic backpressure mechanism. Such backpressure schemes are made possible because of the dual-mode nature of the multi-network interfaces 802 and 804 and the fact that they carry the BEP data in its native mode. In contrast, GFP and other such mechanisms lack node-to-node flow control due to their encapsulated nature.

The path of the backpressure is indicated by the dashed lines shown in FIG. 8. The backpressure typically follows the path of the original data stream, but is not necessarily limited to such. In the embodiment shown in FIG. 8, the BEP backpressure traverses the demultiplexers in multi-network interfaces 802 and/or 804, and arrives at the layer two switch 810 in the packet switching fabric 806. The layer two switch 810 may respond to the backpressure by buffering at least some of the BEP data in one or more buffers 814 until the backpressure is no longer received. Alternatively or additionally, the layer two switch 810 may forward the backpressure to the BEP interface 808, which may respond to the backpressure by buffering at least some of the BEP data in one or more buffers 812 until the backpressure is no longer received. If the multi-network interfaces 802 or 804 are configured with a buffer, they may buffer the BEP data as well. If one or more of the buffers 812 and 814 become full, then the BEP data may be dropped according to some criteria, e.g. by arrival time, priority, source address, destination address, or any other criterion.

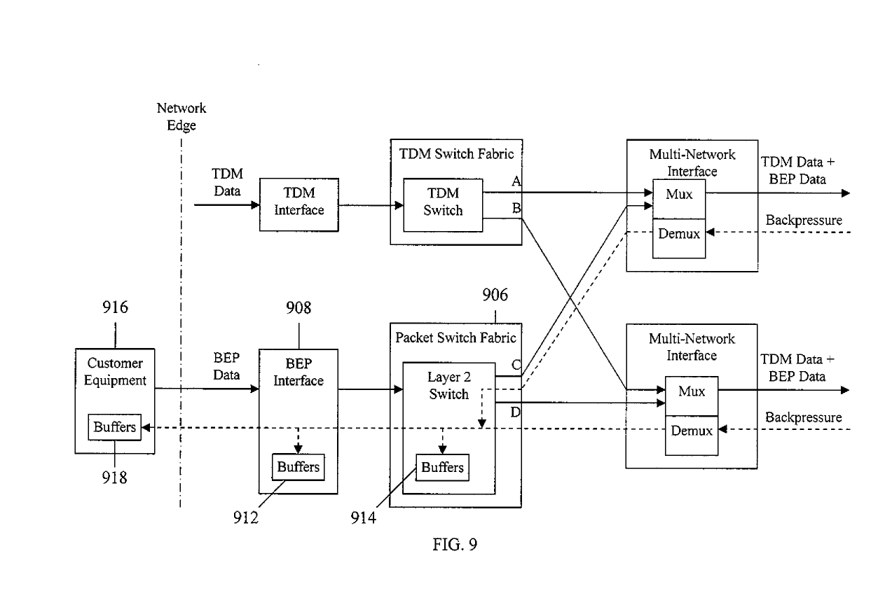

In another embodiment shown in FIG. 9, the backpressure may be directed to a specific location or BEP priority level. Specifically, the backpressure may contain an indicator that specifies the location at which the BEP data should be buffered. For example, the backpressure may indicate whether the BEP data should be buffered at buffers 914 in the packet switch fabric 906, in buffers 912 in the BEP interface 908, or in one or more buffers 918 outside of the network, for example inside the customer equipment 916. In some embodiments, the BEP data may contain an indicator that differentiates one type of packet from another, e.g. by priority, QoS, source address, destination address, or some other differentiation criterion. In such a case, some types of packets may be sent to individual buffers 912, 914, and/or 918, while other BEPs pass through the packet switch fabric 906, the BEP interface 908, and/or the customer equipment 916 unbuffered. Moreover, the backpressure may be directed at the individual types of packets, individual buffers, or both.

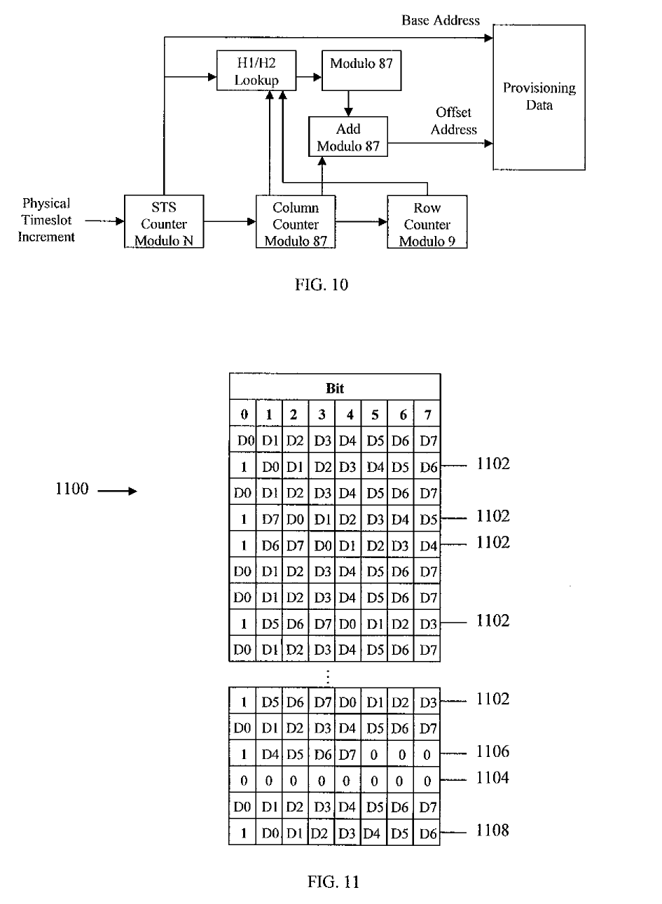

When the BEP data is multiplexed with the TDM data, the nodes need some way to distinguish between the BEP data, the TDM data, and the other types of data, e.g. synchronization data, control data, overhead, and so forth. One method for distinguishing between these types of data is a timeslot map that indicates which timeslots can be reused by the BEP data. The timeslot map may be applicable to various types SDH/SONET frames, for example, STM-16 SDH frames, STM-64 SDH frames, STS-48 SONET frames, STS-192 SONET frames, or combinations thereof. The indication of which timeslots can be reused by BEP data may be derived from the TDM provisioning data contained on a line interface card or from the time-based timeslot identification inherent to SDH/SONET interfaces. For SDH/SONET payload-mapped BEP data, the timeslot map covering the payload area may be referenced to the individual synchronous transport signal (STS) synchronous payload envelopes (SPEs). Specifically, the H1 and H2 pointer interpretation may have to be done on a per-STS SPE basis to determine the start of the SDH/SONET SPEs and to index correspondingly into the provisioning data. One embodiment of a process of doing such for a SONET link comprising N STS SPEs is illustrated in FIG. 10. A similar process may be used for SDH links using the VC-3 plus two columns of fixed stuff

BEP data may be transported using a variety of encodings that are normally tied to the physical layer or its bandwidth. For example, these encodings may support a minimum IPG of twelve octets, a seven-octet preamble, and a start-of-packet indicator. When transported internally to a system, this overhead can be discarded, such that only the basic packet delimitation information is provided.

In one embodiment, the BEP data is encoded using a 7B/8B encoding scheme, an example of which is shown in FIG. 11. In the 7B/8B encoding scheme, one signaling bit is added for every seven bits of BEP data. In addition, the position of the signaling bit is fixed in the first bit of every octet of the SDH/SONET frame that is reused by BEP data. The signaling bit is shown in bold in FIG. 11, where rows 1102 carry BEP data. When the signaling bit is set to zero, the octet is idle. A minimum of one idle octet may be required to delineate the individual BEPs as shown in row 1104. When the signaling bit is set to one, the BEP data is valid, e.g. the subsequent data is BEP data. If the BEP data is transitioning to an idle state within an octet, the remainder of the octet is filled with zeros, as shown in row 1106. BEP data that is transitioning to an active state may be justified to the beginning of the octet ash shown in row 1118. In the 7B/8B encoding scheme, the overhead is one bit per seven bits, or about 14 percent overhead. Thus, the maximum bandwidth utilization is about 86 percent. However, any comparison with the bandwidth normally available on an Ethernet link should take into consideration the fact that some of the bandwidth is recovered from removal of idle periods and suppression of the preamble. In addition, the BEP data may be resynchronized at startup or after a fault by detecting eight consecutive zeros, which indicates an idle period that is part of the IPG. The first subsequent non-zero bit in the BEP data will then be the first signaling bit of the next BEP.

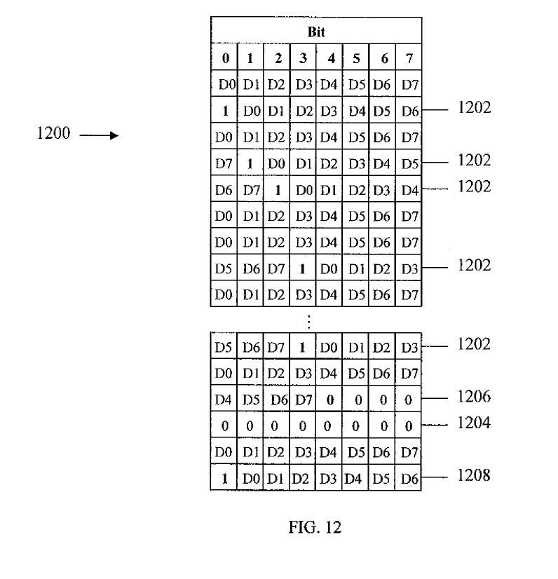

In one embodiment, the BEP data is encoded using an 8B/9B encoding scheme, an example of which is shown in FIG. 12. In the 8B/9B encoding scheme, one signaling bit is added for every eight bits of BEP data. In addition, the position of the signaling bit varies in the SDH/SONET frame that is reused by BEP data. Specifically, the signaling bit follows the end of the previous octet. The 8B/9B encoded BEP octet is shifted, signaling bit first, into the available timeslots of the SDH/SONET data stream. The signaling bit is shown in bold in FIG. 12, where rows 1202 carry BEP data. When the signaling bit is set to zero, the octet is idle. A minimum of one idle octet may be required to delineate the individual BEPs as shown in row 1204. When the signaling bit is set to one, the BEP data is valid, e.g. the subsequent data is BEP data. When the BEP terminates in a particular octet of the SDH/SONET data stream, the remainder of the octet is filled with zeros as shown in row 1206. As shown in row 1208, all the following octets available to the BEP data may be filled with zeros, including the signaling bit, until a new BEP is ready to be transmitted. The new BEP may start in the first available octet of the SDH/SONET data stream. The BEP data stream may be interrupted by TDM traffic at any time. The BEP data may then be resynchronized at startup or after a fault by detecting nine zeros in a row in the BEP data. This indicates an idle period that is part of the IPG. The first non-zero bit in the BEP data will then be the first signaling bit of the BEP data.

Other encoding formats may be used as well. For example, an 8B/10B encoding scheme may be used for the overlay synchronous timeslot schemes described herein. In such a case, two signaling bits are used for every ten bits of BEP data. The 8B/10B encoding scheme may be similar to the Gigabit Ethernet encoding scheme defined by IEEE 802.3™, which is incorporated herein by reference. Alternatively, a 64B/66B encoding scheme may be used for the overlay synchronous timeslot schemes described herein. In such a case, two signaling bits are used for every 64 bits of BEP data. The 64B/66B encoding scheme may be similar to the ten Gigabit Ethernet encoding scheme defined by IEEE 802.3™, which is incorporated herein by reference. Further in the alternative, a 64B/65B encoding scheme could be used for the overlay synchronous timeslot schemes described herein. In such a case, one signaling bit is used for every 64 bits of BEP data. The BEPs may be delineated using a combination of the signaling bit and the Ethernet SFD that is used to identify the start of the Ethernet frame. The end of the BEP may be identified using a combination of the signaling bit and the Ethernet frame check sequence (FCS). The idle state between BEPs, e.g. the IPG between the end of one BEP and the beginning of a subsequent BEP, may be identified using a combination of the signaling bit and a predefined pattern that is used to indicate the idle state of the packet. Thus, the 64B/65B encoding scheme is simpler and has less overhead than the 64B/66B encoding scheme.

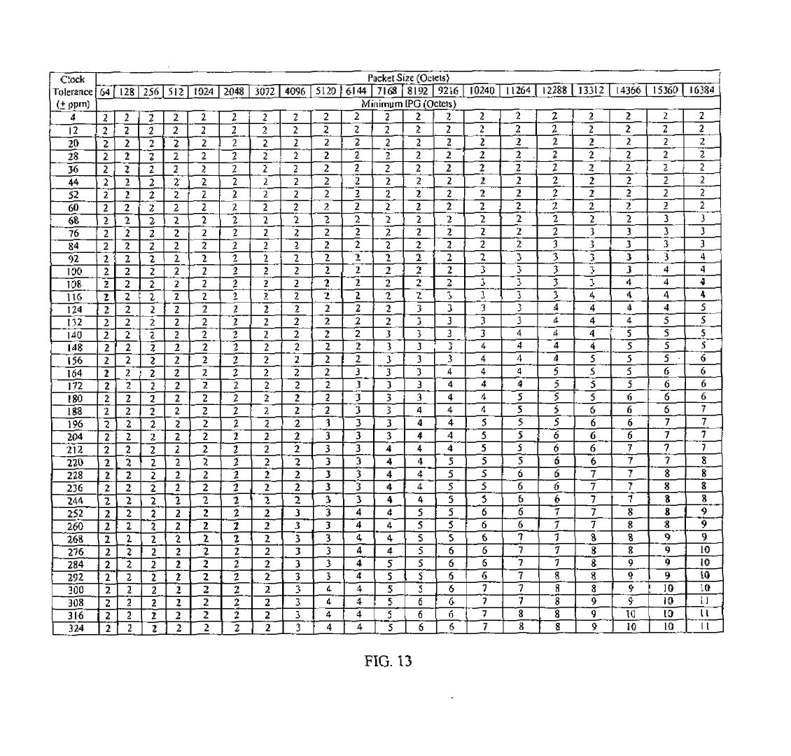

The data rate may be adapted for various sizes of IPGs. The basic principle behind rate adaptation based on IPG size manipulation is that the packet flow, when originally created, should contain IPGs of a sufficient size to allow for shrinkage of the IPG due to the worst-case frequency variations without affecting the packet before or after the IPG. In an embodiment, the size of the IPG may be determined in a manner similar to traditional Ethernet data. Specifically, the size of the IPG may be calculated for each individual link and may be dependent on the clock tolerance of the two nodes coupled to the link and/or the size of the BEP. FIG. 13 illustrates the IPG sizes for several different combinations of packet size and clock tolerance. The IPG sizing can be determined statically by calculating the worst case IPG using the largest packet size supported by the system. Alternatively, IPG sizing can be done dynamically by generating an IPG based on the packet that preceded the IPG. The IPG is generated when the BEP data is inserted in the SDH/SONET data steam. In some embodiments, a minimum IPG of one octet is needed by the protocol to identify the boundaries of the BEPs. Any number of additional octets may be inserted during the IPG generation process to allow for frequency and phase tolerance. Once the BEP data has been generated with the correct IPGs, it may only be necessary to adjust the IPGs in the network to match the local frequency if it is different from the sourcing BEP originating frequency. Such may be done by adding octets to or subtracting octets from the IPGs. A default IPG size can be used, based on the values calculated in FIG. 13, or, alternatively, an IPG size can be calculated dynamically from the size of the BEP previously transmitted. If the buffer is empty, only idle octets are transmitted.

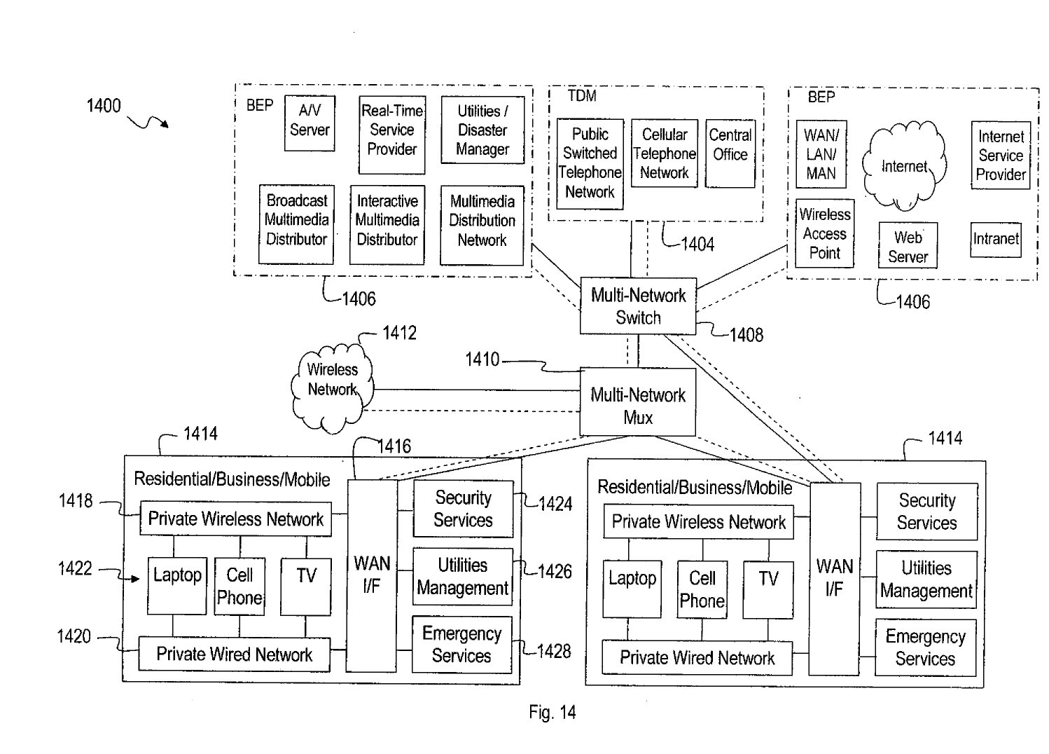

FIG. 14 illustrates an exemplary network architecture 1400 for communicating TDM and BEP data. The network architecture 1400 comprises a plurality of service providers or data producers 1404 and 1406, at least one multi-network switch 1408 that may act as a backbone network, at least one multi-network multiplexer 1410 that may act as an access network, and a plurality of service users or data consumers 1414. The data producers 1404 and 1406 may be TDM data producers 1404 and/or BEP data producers 1406. Persons of ordinary skill in the art will recognize that each of the data producers 1404 and 1406 may also receive data, such as requests for data or services or back channel information from consumer devices. The TDM data producers 1404 may comprise the PSTN, a central office coupled to the PSTN, or a cellular telephone network. The BEP data producers 1406 may comprise an audio/video (A/V) server, a broadcast multimedia distributor, an interactive multimedia distributor, a multimedia distribution network, a real-time service provider, and a utilities/disaster manager. The BEP data producers 1406 may also comprise a wide area network (WAN), a local area network (LAN), a metro area network (MAN), an intranet, the Internet, an internet service provider, a wireless access point, or a web server.

While some examples of the data producers 1404 and 1406 are described above, these are merely exemplary lists and do not exhaustively describe all of the data producers 1404 and 1406. Further, while each of the data producers described above is categorized by the data type they produce, it is contemplated that some data producers may be categorized under two or more data types. For example, an interactive multimedia distributor may transmit multimedia data as BEP data in situations when a multimedia presentation is not intended for immediate playback, but is rather downloaded to a consumer device, such as a set top box, to be played back later. The same interactive multimedia distributor may also transmit TDM data if the multimedia data is meant to be viewed substantially in real-time.

The backbone network of the network architecture 1400, including at least one multi-network switch 1408, may be coupled to each of the data producers 1404 and 1406 through at least one Ethernet or SONET/SDH link. The solid lines represent Ethernet links and the dashed lines represent SONET/SDH links. For example, the multi-network switch 1408 may be coupled to the A/V server though an Ethernet link, and may be coupled to a central office or the PSTN through a SONET/SDH link. The multi-network switch 1408 may be coupled to the TDM-based networks without a media gateway because the multi-network switch 1408 may be able to communicate TDM data in its native mode over both SONET/SDH interfaces and Ethernet interfaces. As such, the TDM and BEP data may not need to be buffered, encapsulated, or otherwise modified prior to communication by the multi-network switch 1408. The multi-network switch 1408 may be one of the multi-network switches described above. Further, the multi-network switch 1408 may comprise a plurality of multi-network switches arranged as the unified network described above. As such, the multi-network switch 1408 may communicate the TDM and BEP data over the backbone network to the multi-network multiplexer 1410, or directly to the data consumers 1414.

As mentioned above, the multi-network multiplexer 1410 may act as an access network in the network architecture 1400. As such, the multi-network multiplexer 1410 may provide the “last mile” communication to the data consumers 1414. For example, the multi-network multiplexer 1410 may communicate with the data consumers 1414 via an Ethernet link, or using other conventional “last mile” technologies such as communicating over a wireless network 1412, a twisted wire pair, a coaxial cable, a passive optical network, or fiber-to-home. In an embodiment, the multi-network multiplexer 1410 may be part of or used in conjunction with an access provider.

The data consumers 1414 may be any residential, business, or mobile device customer or service user. Persons of ordinary skill in the art will recognize that the data consumers 1414 may also produce data such as documents, spreadsheets, pictures, movies, and other data that may be sent to other data consumers 1414 and/or the data producers 1404 and 1406. The data consumers may comprise a WAN interface 1416 that communicates with a plurality of consumer networks and devices. Specifically, the consumer networks and devices may comprise a private wireless network 1418, a private wired network 2140, and a plurality of consumer devices 1422, such as a laptop computer, a cellular telephone, and a television. Further, the WAN interface 1416 may enable communication with locally implemented services at the consumer's location, such as security services 1424, utilizes management 1426, and emergency services 1428.

Thus, at least in some embodiments, the network architecture 1400 depicted in FIG. 14 is believed to provide several advantages. For example, the network architecture 1400 provides easier inter-working with the existing PSTN networks in the form of reduced format conversion/media gateway requirements and efficient support of voice services via a reduced need for echo cancellers. In addition, the network architecture 1400 provides easier inter-working with legacy SONET and SDH networks, easier implementation of packet-based services with high QoS requirements, and the possibility of global synchronization of IP/Ethernet networks while maintaining backwards compatibility with legacy packet-based equipment in the form of logic and memory savings in current networking components. Furthermore, the network architecture 1400 provides support for a low-loss-rate, low-latency, and low-jitter conduit along with the advantages of a packet network, and alleviates IP QoS implementations. Finally, the network architecture 1400 provides a reduction and/or elimination of various QoS support mechanisms, such as advanced queuing schemes or jitter buffers.

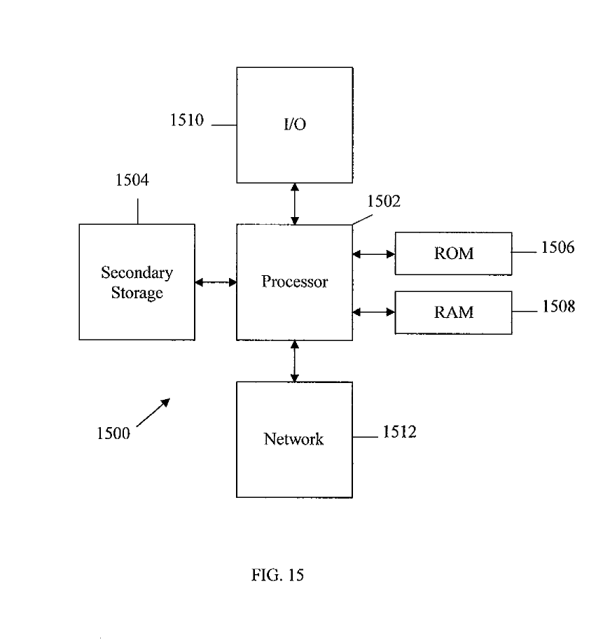

The network described above may be implemented on any general-purpose network component, such as a computer or network component with sufficient processing power, memory resources, and network throughput capability to handle the necessary workload placed upon it. FIG. 15 illustrates a typical, general-purpose network component suitable for implementing one or more embodiments of a node disclosed herein. The network component 1500 includes a processor 1502 (which may be referred to as a central processor unit or CPU) that is in communication with memory devices including secondary storage 1504, read only memory (ROM) 1506, random access memory (RAM) 1508, input/output (I/O) devices 1510, and network connectivity devices 1512. The processor may be implemented as one or more CPU chips, or may be part of one or more application specific integrated circuits (ASICs).

The secondary storage 1504 is typically comprised of one or more disk drives or tape drives and is used for non-volatile storage of data and as an over-flow data storage device if RAM 1508 is not large enough to hold all working data. Secondary storage 1504 may be used to store programs that are loaded into RAM 1508 when such programs are selected for execution. The ROM 1506 is used to store instructions and perhaps data that are read during program execution. ROM 1506 is a non-volatile memory device that typically has a small memory capacity relative to the larger memory capacity of secondary storage 1504. The RAM 1508 is used to store volatile data and perhaps to store instructions. Access to both ROM 1506 and RAM 1508 is typically faster than to secondary storage 1504.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
at least one component configured to implement a method comprising:
inserting best effort packet (BEP) data into a synchronous digital hierarchy (SDH)/synchronous optical network (SONET) frame without encapsulating or reframing the BEP data.

2. The apparatus of claim 1, wherein the SDH/SONET frame comprises an overhead and a payload, and wherein the BEP data is inserted into the payload and not inserted into the overhead.

3. The apparatus of claim 1, wherein the SDH/SONET frame comprises an overhead and a payload, and wherein the BEP data is inserted into the payload, the overhead, or combinations thereof.

4. The apparatus of claim 1, wherein the method further comprises:
interrupting the BEP data when time division multiplexed (TDM) data is received; and
continuing the BEP data when the TDM data is no longer being received.

5. The apparatus of claim 1, wherein the BEP data is inserted into the SDH/SONET frame using a timeslot map.

6. An apparatus comprising:
a synchronous digital hierarchy (SDH)/synchronous optical network (SONET) framer; and
a multiplexer coupled to the SDH/SONET framer, wherein the multiplexer is configured to receive native-form best effort packet (BEP) data.

7. The apparatus of claim 6, wherein the SDH/SONET framer is located downstream of the multiplexer, and wherein the multiplexer is further configured to receive unframed time division multiplexed (TDM) data.

8. The apparatus of claim 6, wherein the SDH/SONET framer is located upstream of the multiplexer, and wherein the multiplexer is further configured to receive framed time division multiplexed (TDM) data.

9. The apparatus of claim 6, wherein the multiplexer is further configured to receive control data, time division multiplexed (TDM) data, and synchronization data.

10. The apparatus of claim 6, further comprising a SDH/SONET interface.

11. The apparatus of claim 6, farther comprising:
a controller coupled to the multiplexer; and
a buffer coupled to the multiplexer.

12. The apparatus of claim 11, wherein the controller comprises a timeslot map.

13. An apparatus comprising:
at least one component configured to implement a method comprising:
receiving time division multiplexed (TDM) data;
receiving best effort packet (BEP) data;
switching the TDM data using a TDM switch fabric;
switching the BEP data using a packet switch fabric; and
transmitting at least some of the TDM data and the BEP data over a single interface without encapsulating the BEP data.

14. The apparatus of claim 13, wherein the packet switch fabric is an Ethernet layer two switch fabric.

15. The apparatus of claim 13, wherein the method further comprises:
multicasting the TDM data to a plurality of ports; and
load-sharing the BEP data across the ports.

16. The apparatus of claim 13, wherein the method further comprises:
receiving backpressure from a downstream node; and
buffering the BEP data without buffering the TDM data.

17. The apparatus of claim 13, wherein the method further comprises:
receiving backpressure from a downstream node; and
forwarding the backpressure to an upstream node.

18. The apparatus of claim 13, wherein the method further comprises receiving backpressure from an upstream node, wherein the backpressure indicates a location where the BEP data should be buffered.

19. The apparatus of claim 13, wherein BEP data comprises a plurality of types, and wherein the method further comprises receiving backpressure from an upstream node, wherein the backpressure indicates that less than all of the BEP types should be buffered.

20. The apparatus of claim 13, wherein the BEP data is transmitted using a 7B/8B encoding scheme, an 8B/9B encoding scheme, or a 65B/66B encoding scheme.
